(19) United States
(12) Patent Application Publication
(10) Pub. No.: US 2011/0106581 A1
(43) Pub. Date: May 5, 2011

(54) METHOD FOR VISUALIZING CUSTOMER INSIGHTS

(75) Inventors: Patrick Rohrbasser, Starnberg (DE); Sandro Götz, Baldham (DE)

(73) Assignee: emnos GmbH

(21) Appl. No.: 12/609,241

(22) Filed: Oct. 30, 2009

(51) Int. Cl. G06Q 10/00

(52) U.S. Cl. 705/7.29

(57) ABSTRACT

A method for visualizing customer insights, comprising the steps of: receiving information data including at least one of transaction, product, shop and customer-related information data; generating a predefined analysis report by associating respective information included in the received information data with each other; parameterizing the generated analysis report with at least one user defined parameter; and outputting the parameterized predefined analysis report.

### FIELD OF THE INVENTION

The present invention refers to a method, a computerized system and a computer-readable medium comprising instructions for executing the method for visualizing customer insights.

### BACKGROUND OF THE INVENTION

Today, retailers have to plan, evaluate and revise advertising strategies individually not only for their shop(s), but also for the single products. At best, advertising strategies are custom-tailored. However, custom-tailored advertising requires detailed knowledge about the customers, their demands, and their wishes etc.

Furthermore, retailers have to know the market conditions, since otherwise advertising might not be successful. For instance, imagine that an advertisement offers a price for a product which is higher than the price of a competitor's advertisement. At best, only customers who have a deep loyalty to the retailer's shop might buy in such a case the more expensive product.

In order to get the required information, it is known to collect and analyze retail sales data. Accordingly it is usual that retailers and their suppliers collect data from retail transactions.

Such retail transaction data and/or consumer data can be analyzed in different ways. For instance, from US 2006/0069585 A1 it is known to provide, based on the retail transaction data and/or consumer data, projects, which are generated as spreadsheet based interactive reports. A user can select via a user interface an analysis project from a predefined list of available analysis projects to answer thereby predefined business questions.

### SUMMARY OF THE INVENTION

According to a first aspect the invention provides a method for visualizing customer insights, comprising the steps of: receiving information data including at least one of transaction, product, shop and customer-related information data; generating a predefined analysis report by associating respective information included in the received information data with each other; parameterizing the generated analysis report with at least one user defined parameter; and outputting the parameterized predefined analysis report.

According to a second aspect, the invention provides a computerized system for visualizing customer insights, comprising: at least one database having information data including at least one of transaction, product, shop and customer-related information data; a first computer-based system having access to the database and being configured to perform the steps of: receiving a request for generating a predefined analysis report; receiving a user defined parameter; generating the requested predefined analysis report by associating respective information included in the information data with each other and parameterizing the generated predefined analysis report with at least one user defined parameter; outputting the parameterized requested predefined analysis report.

According to a third aspect the invention provides computer-readable medium including instructions which cause a computer-based system to perform the steps of: receiving information data including at least one of transaction, product, shop and customer-related information data; generating a predefined analysis report by associating respective information included in the received information data with each other; parameterizing the generated analysis report with at least one user defined parameter; and outputting the parameterized predefined analysis report.

Further aspects of the invention are set forth in the dependent claims, the following description and the drawings.

### BRIEF DESCRIPTION OF THE DRAWINGS

Embodiments of the present invention are explained by way of example with respect to the accompanying drawings, in which:

FIG. 1 illustrates an embodiment of a computerized-system for visualizing customer insight;

FIG. 2 shows a flow chart of a method in accordance with the present invention;

FIG. 3 illustrates the visualization of a key measure report;

FIG. 4 illustrates the visualization of a assortment analysis report;

FIG. 5 illustrates the visualization of a cross purchase report;

FIG. 6 illustrates the visualization of a repeat purchase report;

FIG. 7 illustrates the visualization of a switching report; and

FIG. 8 illustrates the visualization of a customer profile report.

### DETAILED DESCRIPTION OF EMBODIMENTS

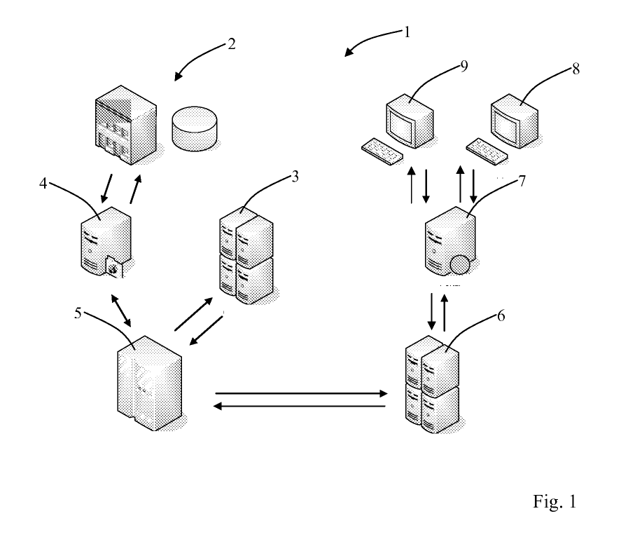

FIG. 1 illustrates an embodiment of a computerized system for visualizing customer insights. Before proceeding further with the detailed description of FIG. 1, however, a few general items will be discussed.

To win in today's challenging environment, retail and consumer businesses need to put their customers at the centre of their business. Successful companies globally have accelerated growth and created differentiation by harnessing customer insights to drive better strategic decisions as well as supporting day-to-day operations. In order to achieve such aims, it is necessary to analyze customer insights and core KPIs (key performance indicators).

The analysis of customer insights and core KPI does not only require fundamental knowledge about mathematics, statistics, information technology, etc., but it needs also detailed data sets about customers and transactions to gain the required knowledge.

The collection of such data sets and its analysis is the basis for the generation of reports answering relevant business questions. US 2006/0069585 A1, pertains to the analysis of transaction data or retail sales data. It provides, based on the retail transaction data and/or consumer data, projects, which are generated as spreadsheet based interactive reports. A user can select via a user interface an analysis project from a predefined list of available analysis projects to answer predefined business questions.

It has been recognized by the present inventor that providing a predefined list of available analysis projects is not flexible and it does not allow to providing individual analyses of individual business questions.

In the embodiments described, it is possible to analyze information data including at least one of transaction, product, shop and customer-related information data. Such data may be received, for example, from retailers sending the information as retailer data to a server, which stores them e.g. in a database. From the information analysis reports can be generated which are further parameterized with at least one user defined, i.e. individual, parameter. The individual parameter can be input by a user in order to answer individual business questions, such as:
Who are our most valuable customers? What is their future potential?
How do customers use the product offering? What needs do they fulfill?
Who are the price sensitive customers? What products are really relevant for them?
Which customers should get what marketing message? How often?
How efficient are marketing and promotion activities?
How successful was the latest new product launch?
etc.

The parameterization of the generated analysis reports and a respective analysis of the thereby generated reports allows:
measuring the performance of products, product groups, categories, stores, strategies and actions
executing immediate impact analyses of actions (product launch, promotion, withdrawal)
evaluating impact of marketing actions on customer segments
monitoring and reviewing actions at global or store level
understanding customer profiles in regard to products and categories
building a common understanding of customer behaviour
defining a regular follow up of customer behaviour on the product or category
getting customer and market insights for product innovation, promotion, cross merchandising and targeted communications
etc.

In some embodiments, the information data including at least one of transaction, product, shop and customer-related information data are received, for example, from a server or host computer (from a retailer, data warehouse or the like). The information data can be based on at least one of point-of-sale data, retailer data, transaction data, household data, shopping card data, consumer data being based on at least one of demographic data, shopping preference data and financial data. The received information data is analyzed based on associating respective information included in the received information with each other data and a, for example, predefined analysis report is generated.

The associated information includes, for example, at least one of unique identifier, customer birthday, employee status, customer gender, nation description, town, postal code, identifier of customer, identifier of the household, customer start date, product, item quantity, price of position, identifier of shop, identifier of transaction, date of transaction, etc.

By associating the respective information with each other, which is known to the skilled person, analysis reports can be generated, such as key measure report, assortment analysis report, cross purchase report, repeat purchase report, switching report and customer profile report. These predefined reports, which are based on the respective associated information, can be parameterized with a user defined parameter selected or defined by a user.

The predefined analysis report can be generated or prepared completely or in a preliminary version before it is parameterized and, thus, it covers the collection of the associated information data as well as the association of the information data and the analysis of the associated information data. Hence, a generated predefined analysis report is, for example, a generated or prepared collection of information data and/or association of information data and/or analysis of the collected or associated information data, and which is based on predefined parameters which are associated with a predefined analysis report.

The user defined parameter is based, for example, on at least one of time interval, branch, store, brand, product, group of products and user defined data sets. User-defined data sets can be defined based on a product hierarchy, pre-defined product groups, import of stock keeping unit data, user defined time intervals or the like.

The parameterized predefined analysis report is outputted for further visualization and includes, e.g. customer-insight related data or the like. In some embodiments, the parameterized predefined analysis report is stored in database, such that a user can access it on demand, e.g. via a web portal.

The key measure report can be based on associating, for example, information related to a specific product or product group and a specific time period, thereby visualizing the performance of the specified product. The key measure report delivers, for example, key aspects of customer shopping behaviors and highlights in the visualization of the outputted data which KPIs are contributing to topline sales changes and answers thereby the business question what the key customer drivers behind a category performance are. The business question which customer segments are driving sales answers the key measure report by delivering metrics at a segment level. Moreover, the key measure report answers the business question how the behavior of customers changed compared to preceding period of time by showing the customer behavior across time periods and the customer behavior over time. Also the business question how a brand is performing in the context of a total category can be answered by the key measure report by delivering metrics down to product level and/or enabling comparisons for products and/or brands with the total category or competition.

The key measure report allows a user to compare key figures about the performance by being parameterized with a user defined parameter, such as products between two selected periods, e.g. before and after a promotion, change of price, a launch or similar. Furthermore, factors explaining the evolution of turnover from a client perspective can be identified, the top products on various customer KPIs can be identified and products, which are over- or under-consumed by a customer segment can be identified.

The assortment analysis report can be based on associating information, for example, related to attributes of customers who have purchased a first group of products with attributes of customers who have purchased a second group of products. The assortment analysis report allows to compare and to contrast the attributes of customers who have purchased one group of products against the attributes of customers who have purchased another group of products. It can be visualized in two dimensions, e.g. weekly sales against repeat purchase rate. The assortment analysis report is able to answer the business question, for example, how the number of SKUs (stock keeping units) can be reduced, since the report allows the user to rate SKUs on two scalable criteria, such as loyalty rate and sales. Thereby, the assortment analysis report helps to answer the questions, whether delisting a SKU with poor sales affects the most loyal customers. Moreover, the user can select, for example, two or more poor selling SKUs depending on their loyalty as second set of parameters.

The cross purchase report can be based on associating information, for example, related to a vendor of a product and a specified product. The cross purchase report shows e.g. groups of customers shopping across different products or product groups. The report shows, for example, the number of people who just bought each product group and/or brand and/or category and did not buy into any other product in the category, thereby answering the business question how many people are loyal buyers of a product and/or brand and/or category. Furthermore, the cross purchase report can show the number of people who repertoire shop across the category or product groups. This answers the business questions, how many repertoire customers are there and how many products the shop across. Thus, this report show the importance of repertoire and the relative number of products bought. The cross purchase report can also visualize the value of each loyal and repertoire purchase group and display the importance of each customer group and the potential impact of band or category marketing activities, thereby answering the business question what loyal and/or repertoire purchasers are worth. The cross purchase report can also show customer profiles of different customer segments in order to enable the understanding of what type of marketing activity will drive customer behavior. This answers, e.g. the business question what the profile of the loyal and repertoire shoppers is. The cross purchase report provides necessary information to build a strategy to change customer repertoire behavior, e.g. spend, repertoire, single product importance, etc., thereby answering the business question how much brand and/or category sales might be driven by capturing more of the customer's spend. The level of repertoire purchase and the type of customers involved visualizes where the brand is not meeting the needs of a segment and, thereby, gives an indication of what those needs might be. This helps answering the question whether the category and/or brand meets the needs of all shoppers.

The repeat purchase report can be based on associating information, for example, related to a specific product with attributes of customers. The repeat purchase report visualizes, for example, on a week-by-week basis the behavior of customers buying a brand or a product in terms of number of recruited customers and number of loyal customers. By showing repeat purchase behavior at product level, the repeat purchase report enables quicker and better decision-making that is crucial to new product success and helps to answer the business question, whether people are repeat purchasing a new product launch. Furthermore, the repeat purchase report benchmarks the customer behavior versus other products and enables the comparison versus competition and/or rest of category and/or similar launches. This answers the business question, whether people respond to new products as well as other products. The repeat purchase report also provides cumulative sales statistics over time periods, for example up to a 52 weeks period. Thus, the repeat purchase report enables user to understand whether purchases are coming from loyal consumers, i.e. repeat purchases, or are generated via trial and thereby answers the business questions, whether a new product launch has been successful. The repeat purchase report shows, if a repeat purchasing drops after a promotion, it demonstrates if a promotion has successfully driven trade or just brought purchasing forward and it show average days between purchases for products. Thus, the repeat purchase report also answers the business question how a recent promotion changed the behavior of shoppers.

The switching report can be based on associating information, for example, related to customers with at least two specific products. The switching report helps to understand how customer shopping behavior changes when new products are introduced, items are put on promotions, or products are removed from the range and compares how the distribution of the spend of the shoppers of the main product set in a second period evolved between two periods. The report shows the gains and losses between particular brands over time periods and it can be used to visualize the effect of promotional activity or other market intervention. Thus, the switching report answers the business question how many people were attracted from other categories and/or brands or whether people were cannibalized from the own brand. Furthermore, the switching report also visualizes the effects of new brand introductions or de-listings on the existing assortment and it can be used for new or different types of marketplace interventions, e.g. price changes and helps thereby to answer the business question what happens if a product is delisted and where the customers go in this case.

The customer profile report can be based, for example, on building customer profiles by grouping customers with similar attributes and associating the resulting customer profilers with at least one specific product. The customer profile report allows comparing and contrasting the attributes of customers who have purchase one group of products against the attributes of customers who have purchased another group of products. The customer profile report provides insight into customer segment behavior and helps to understand how segments react on different promotion mechanics or how the are under or over served by current offerings. This answers e.g. the business question what type of customers buy into a category, sub-category, brand or product. The customer profile report visualizes the customer spend by segment and gives a benchmark number of customers versus value in the category. This answers how much each customer group contributes to a category sales. Moreover, the customer profile report visualizes which customer segments are not purchasing into the category and/or brand, thereby answering the business questions if there are any customers who are not buying into the category and/or brand. The visualization of index versus total category or overall store helps to understand which customer segments are under or over served. This supports the assessment whether a category and/or brand profile is different to the rest of a store.

Thus, the present invention provides a very flexible and common way of analyzing across different users and category departments. It offers a user the possibility to view and analyze transaction data on different levels, such as store level, category level, brand level, product/SKU level, and user defined data sets and/or product groups. In some embodiments the user can easily define products or products groups via, for example, drag and drop functionality in a product hierarchy, via copy and paste of already existing, i.e. predefined product groups or via data import of SKUs. The predefined reports, as discussed above, are designed to deliver maximum flexibility as the user can define time intervals, products and groups of products for the respective reports as second parameters. This allows user defined analysis and comparison for the respective reports.

The above explained method steps are performed in some embodiments on a computerized system for visualizing customer insights, comprising: at least one database having information data including at least one of transaction, product, shop and customer-related information data; a first computer-based system having access to the database and being configured to perform the steps of: receiving a request for generating a predefined analysis report; receiving a user defined parameter; generating the requested predefined analysis report by associating respective information included in the information data with each other and parameterizing the generated predefined analysis report with at least one user defined parameter; outputting the parameterized requested predefined analysis report.

Thus, the above-mentioned method steps are performed by at least one microprocessor of the computerized system. In some embodiments, the several method steps may also performed on different computer (microprocessor)-based systems. For example, a first computer-based system may perform the information data collection by receiving the information data and storing it in a database. A second computer-based system may analyze the data and generated (predefined) analysis reports which are stored in a further database. A third computer-based system may perform the parameterization of the (stored) analysis reports and outputs the parameterized reports. The reports itself may be received by a fourth computer-based system of user, such as a retailer or supplier, and may be displayed on a display of the fourth computer-based system.

Instructions, which may cause a computer-based system to perform at least some of the above-explained method steps can also be stored on a computer-readable medium. For example, the computer-readable medium, such as a compact disk (CD, DCD, Blueray disk, etc.), a floppy disk, a hard disk, a magnetic tape or a flash memory can include instructions which cause a computer-based system to perform the steps of: receiving information data including at least one of transaction, product, shop and customer-related information data; generating a predefined analysis report by associating respective information included in the received information data with each other; parameterizing the generated analysis report with at least one user defined parameter; and outputting the parameterized predefined analysis report.

Returning to FIG. 1, there is shown an embodiment of a computerized-system 1 in accordance with the present invention. Information data, such as transaction data, shopping/loyalty card data, demographic data, and the like, are sent from a POS (point-of-sale) or data warehouse 2 via a data connection, such as internet, LAN, WLAN or the like, to a COM-server 4 (communication server). The COM-server 4 collects the received transaction data, serving as an interface to the client side built of the POS 2 and provides it via a data connection to a database server 5 having an analytical database, based for example on “Oracle” (www.oracle.com) for analysis and “Greenplum” (www.greenplum.com) for reporting of analysis reports, which are both known to the skilled person in the art. The information data is sorted and grouped respective its information content and stored in the analytical data base of database server 5 for further analysis. The database server 5 is connected to a CCM Tools server 3, which servers to provide customer segmenting and analysis of product assortment. The CCM Tools server 3 deploys, for example, a CCM Tools software package, which is known to the skilled person in the art.

The database server 5 is also connected to a reporting database server 6, which is configured to generate and store predefined analysis reports such as key measure report, assortment analysis report, cross purchase report, repeat purchase report, switching report, and customer profile report or the like by associating respective information which each other as stored in the database.

The reporting database server 6 is further configured to receive a request and user parameter from a portal server 7 which serves as an interface between the reporting database server 6 on the server side and user computer systems 8 and 9 on the client side. Computer system 8 belongs, for example, to a retailer and computer system 9 to a supplier which are using the computer systems 8, 9 for connecting to the portal server 7. The portal server 7 deploys, for example, the “Liferay” software package (www.liferay.com) for providing a respective portal environment which is known to the skilled person in the art. Thus, on the user computer systems 8 and 9 only a small software package has to be run, which allows connection to a web portal running on the portal server 7. The data analysis and report generating is done on the server side.

On the back-end side “Java” and “J2EE” (www.java.com) and on the front-end side “Adobe Flex” (www.adobe.com) are exemplary used, which are also known to the skilled person in the art. The document management, for example, managing generated reports, is based on the “Alfresco”software package (www.alfresco.com).

The portal server 7 also manages, for example, authentication such that only users which can authenticate themselves have access to the portal and reporting database server 6. Furthermore the portal server 7 provides e.g. already generated reports and other documents to the authenticated user.

The information data includes, as mentioned, for example retail transaction data, collected e.g. from electronic point-of-sales, and/or customer/consumer data, i.e. data which is collected with frequent shopper or loyalty cards used by customers when they shop. Additionally, other data can be used known to the skilled person in the art, such as demographic data related to customers or data regarding promotional status of a product and the like. The customer-related information comprises, for example, the information as shown right column “column comment” in table 1. The customer-related information is stored in the database of database server 5 as a data field, such as shown in table 1, with variables as indicated in the column “Column Name” with a data format, as indicated in the column “Format”. Furthermore, table 1 gives an overview, whether a respective variable can be nullable, i.e. if it can have the value zero and which variable includes the “primary key” which is in this case the “CARD_KEY” variable which includes a unique identifier of a customer card.

TABLE 1

| Column | | | | Primary | |
|---|---|---|---|---|---|
| Id | Column Name | Format | Nullable | Key | Column Comment |
| 7 | CARD_END_DATE | DATE | Yes | No | end date of the card |
| 1 | CARD_KEY | VARCHAR2(20) | No | Yes | unique identifier of a customer card |
| 6 | CARD_START_DATE | DATE | Yes | No | begin date of the card |
| 3 | CARD_STATUS_DESC | VARCHAR2(35) | Yes | No | card status description |
| 2 | CARD_STATUS_ID | VARCHAR2(4) | Yes | No | card status id |
| 5 | CARD_TYPE_DESC | VARCHAR2(35) | Yes | No | card type description |
| 4 | CARD_TYPE_ID | VARCHAR2(4) | Yes | No | card type id |
| 22 | CDB_DELETED_DATE | DATE | Yes | No | the date, when this entity is not being |
| | | | | | delivered anymore |
| 20 | CDB_INSERTED_DATE | DATE | No | No | first insertion date of this entity into |
| | | | | | the core database (dd.mm.yyyy |
| | | | | | hh24:mi:ss) |
| 21 | CDB_UPDATED_DATE | DATE | Yes | No | last update date of this entity in the |
| | | | | | core database (dd.mm.yyyy |
| | | | | | hh24:mi:ss) |
| 10 | CST_BIRTH_DATE | DATE | Yes | No | customer birth date |
| 19 | CST_EMPLOYEE_FLG | VARCHAR2(1) | Yes | No | employee flag |
| 12 | CST_GENDER_DESC | VARCHAR2(30) | Yes | No | customer gender desc |
| 11 | CST_GENDER_ID | VARCHAR2(1) | Yes | No | customer gender |
| 16 | CST_NATION_DESC | VARCHAR2(50) | Yes | No | nation description |
| 14 | CST_NATION_ID1 | VARCHAR2(3) | Yes | No | nation id 1 |
| 15 | CST_NATION_ID2 | VARCHAR2(3) | Yes | No | nation id 2 |
| 18 | CST_POSTCODE | VARCHAR2(10) | Yes | No | postal code |
| 9 | CST_START_DATE | DATE | Yes | No | customer start date |
| 17 | CST_TOWN | VARCHAR2(40) | Yes | No | town |
| 8 | CUSTOMER_ID | VARCHAR2(13) | No | No | identifier of customer |
| 13 | HOUSEHOLD_ID | VARCHAR2(18) | No | No | identifier of the household |

The transaction data comprises transaction-based information such as shown in table 2. The type of information is shown in the right column “Column comment” in table 2. Also the trans-action data is stored as a data field in the database of database server 5 with variables as shown in column “Column Name” and variable format as shown in column “Format”. Also table 2 gives an overview, whether a respective variable can be nullable, i.e. if it can have the value zero and which variable includes the “primary key”.

TABLE 2

| Column | | | | Primary | |
|---|---|---|---|---|---|
| Id | Column Name | Format | Nullable | Key | Column Comment |
| 2 | CARD_KEY | VARCHAR2(20) | No | No | identifier of customer card |
| 8 | CDB_INSERTED_DATE | DATE | No | No | insertion date of this entity |
| | | | | | into the core database |
| | | | | | (dd.mm.yyyy hh24:mi:ss) |
| 9 | FILE_ID | NUMBER | No | No | delivery file id |
| 4 | PRODUCT_KEY | VARCHAR2(20) | No | No | identifier of product |
| 6 | QUANTITY | NUMBER | No | No | item quantity |
| 7 | SPEND_AMOUNT | NUMBER | No | No | price of position |
| 3 | STORE_KEY | VARCHAR2(10) | No | No | identifier of store |
| 1 | TRANSACTION_KEY | VARCHAR2(30) | No | No* | identifier of transaction |
| 5 | TRX_DATE | DATE | No | No | date of transaction |

The customer-related information data and the transaction data are sent, e.g. on a daily basis (or any other time period) from a retailer to the COM-server 4 which forwards the information data to the database server 5.

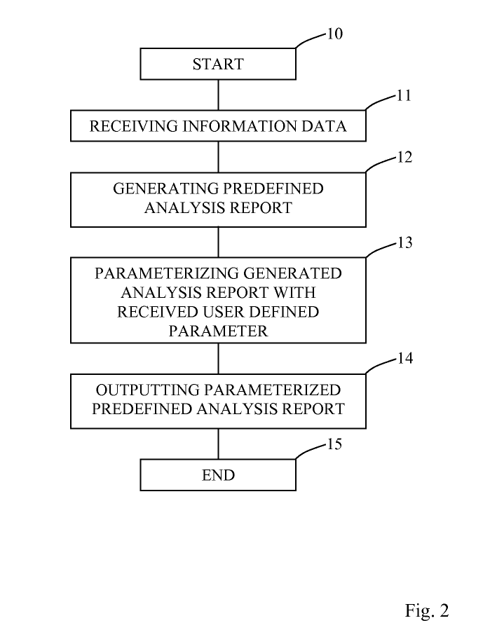

A method for analyzing and visualizing the received information data is now described with reference to FIG. 2 to FIG. 8.

FIG. 2 illustrates a flow chart for a method of visualizing customer insights, which can be performed, for example, on database server 5 and/or on reporting server 6. The method starts at 10 and information data are received at 11. As mentioned above, the information data includes information relating to transaction, product, shop and customer information. The information data is collected, sorted and grouped e.g. in a database such as database on database server 5 and/or reporting server 6.

The information data is further analyzed, based on association respective information with each other. The general generation of analysis reports and which kind of information has to be associated with each other is within the skilled person's common knowledge. For instance, by associating the card identifier of the shopping card data (table 1) and transaction data (table 2) with each other, the information contained in the shopping card data and the transaction data is combined and can be used for further analysis. Thus, it is possible to analyze, which customer purchased at which point of time which kind of product. This analysis can be done for a plurality of information data. Thus, by associating respective information data sets with each other, detailed analysis reports about answering different business questions can be generated, as will be explained in further detail below. For instance, by further association products with purchase time, analysis reports can be generated showing the performance of a specific product for a first and a second period of time, such as a key measure report. By comparing the performance of the specific product for the two time periods, a user can analyze, whether, for example, a promotion was successful or not.

In a further step the method parameterizes the generated analysis report with a received user defined parameter at 13. Such user defined parameters are based on e.g. time interval, branch, store, brand, product, group of products and user defined data sets. The user defined data sets can be based on, for example, a product hierarchy, pre-defined product groups, import of stock keeping unit data, user defined time intervals. The parameterization of the generated analysis report allows a user to visualize the analysis report for its own needs and to answer non-predefined business questions. Thus, by parameterizing the analysis reports with the user defined parameter(s), standard or pre-defined reports become very flexible and can answer user specific business questions in great detail without the need of developing new analysis reports for the specific business questions.

The parameterized generated predefined analysis report is outputted at 14 for visualizing a customer insight, for example, on a computer system of an end user and the method ends at 15.

In some embodiments, the user can easily switch a generated report between different user defined parameters, thereby answering different business questions without the need that analysis has to re-started for answering another business question.

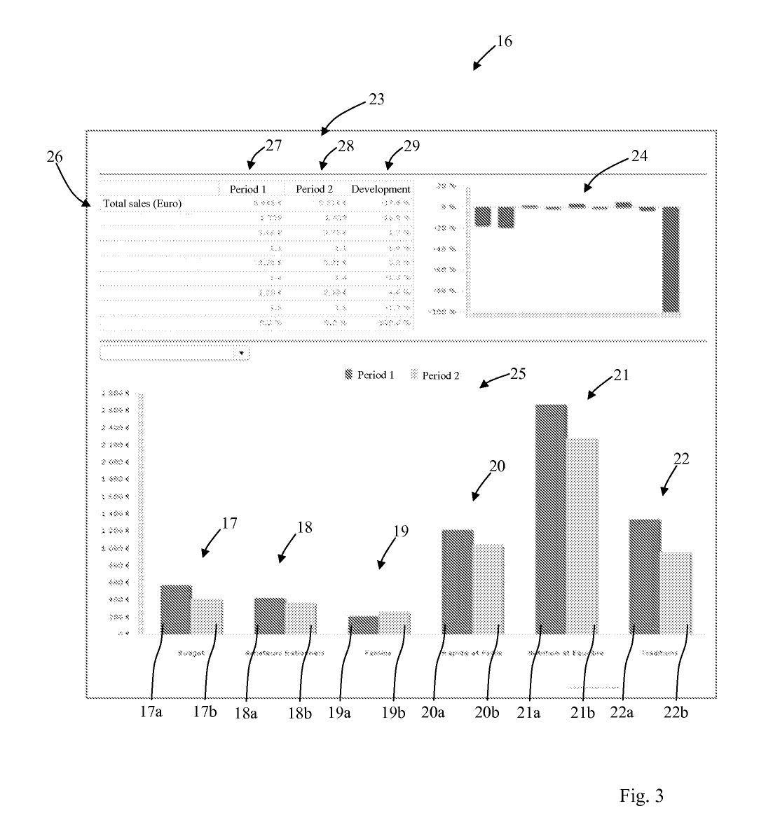

There are predefined analysis reports stored in a database, such as key measure report, assortment analysis report, cross purchase report, repeat purchase report, switching report, and customer profile report and they are now discussed with reference to FIGS. 3 to 8.

FIG. 3 illustrates a visualized key measure report 16. The key measure report 16 is divided into three main areas 23, 24 and 25 and visualizes a comparison of a product performance between two time periods. A first area 23 includes a list of KPIs 26 (key performance indicators), such as total sales, sales per customer, etc. The KPIs are given for the first time period in column 27 and the second time period 28. In a third column 29, the development of the respective KPI is given in percent. This development is also graphically visualized in area 24, showing the development of each KPI of the list of KPIs 26 as a bar diagram. A further area 25 illustrates for the two time periods, “period 1” and “period 2”, the spend of different customer segments 17, 18, 19, 20, 21, and 22 as a bar diagram. Customer segments can be defined, for example, by gender, family status, age, income, their shopping behavior, and the like. For each customer segment 17, 18, 19, 20, 21 and 22 the left bar 17a, 18a, 19a, 20a, 21a, 22a represents the spend for the first time period “period 1” and the right bar 17b, 18b, 19b, 20b, 21b, 22b represents the second for the second time period “period 2”. In the present case the key measure report is parameterized with the user parameter “product”. However, as mentioned before, a user can also define other user parameters, such as branch, store, time periods or product set or user defined data sets based on e.g. product hierarchy, pre-defined product groups, import of stock keeping unit data, and user defined time intervals. The user can easily switch the parameterization of the key measure report (or any other report discussed below) by “clicking” with a pointing device, e.g. on a specific “button” in the visualization, selecting the parameter in drop-down menu, filling a field or any other possibility allowing the user to send a parameter or selection of a parameter to the computer system lying within the skilled person's knowledge.

Hence the key measure report answers, for example, the following business questions:
What are the key customer drivers behind my category performance?
Which customer segments are driving sales?
How has behaviour of my customers changed compared to last period?
How is my brand performing in the context of the total category?
   provides parameterisation flexibility:
Branch
Store
Product, product set
Period
   and provides insights, for example, before and after a promotion, a change of price or a product launch. The key measure report, for example:
Delivers key aspects of customer shopping behaviour
Identifies and compares key figures from a customers point of view
Allows to get a hit parade of the references of the different customer indicators
Identifies which product is under or over consumed in a customer segment
Enables comparisons for products/brands with total category or competition

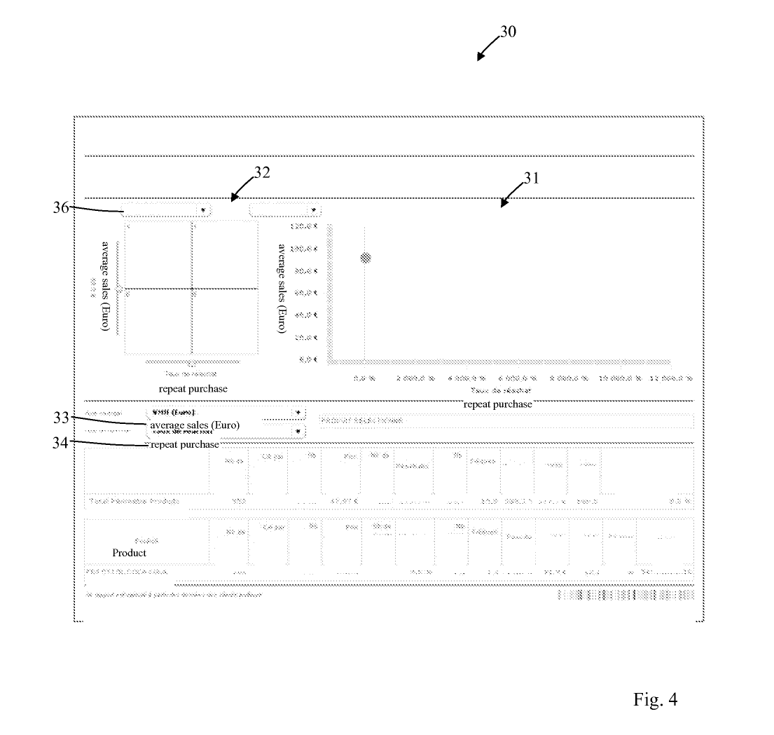

An assortment analysis report 30 is illustrated in FIG. 4. The assortment analysis report is visualized in a two dimensions plot 31. The two dimensions plot 31 compares the attributes of customers who have purchased a first group of products against the attributes of customers who have purchased a second group of products. The two dimensions plot 31 is generated by plotting the repeat purchase rate on the horizontal axis and the average sale per week on the vertical axis of respective customers. A similar two-dimensional plot 32 allows to investigate specific points in the two-dimensional space built out of the average sale per week and the repeat purchase rate by providing respective scroll bars on the vertical and horizontal axes. By activating the scroll bars, the user can scan parts of the two-dimensional plot 32. With pull-down menus 36 further filters can be set, e.g. filters for customer segments, etc. Furthermore pull-down menus 33, 34 are provided for selecting respective parameters for the horizontal and vertical axes visualized in plots 31 and 32. Additionally, on the lower side an area 35 displays KPIs, as discussed in connection with the key measure report above, in columns and for different products in lines. As mentioned above, a user can also define other user parameters than products for parameterization of the assortment purchase report, such as branch, store, time periods or product sets or user defined data sets based on e.g. product hierarchy, pre-defined product groups, import of stock keeping unit data, and user defined time intervals.

This enables the assortment analysis report to answer, for example, the following business questions:
I need to reduce the number of SKUs in my assortment but do not want to delist any SKUs which fulfil special needs in my category.
I am thinking of delisting this SKU, because sales are poor. I want to check though whether I will lose loyal customers if I do this, and moreover I am not sure in how deep a distribution the SKU is.
   to provide parameterisation flexibility:
Branch
Store
Products, product set
Period
   and to provides insights such as the following insights:
Allows to make assortment choices considering the loyalty and commercial performance.
Identifies the products that generate loyalty which need to be boosted by marketing actions.

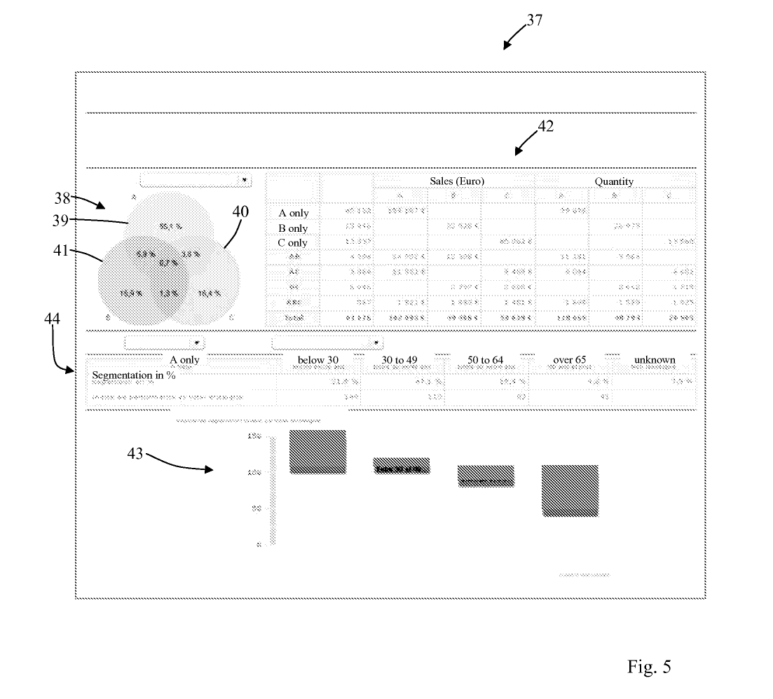

FIG. 5 illustrates a cross purchase report 37, which visualizes the cross purchase of different products or product groups. For the present cross purchase report 37 a user selected three products A, B and C. The visualization of the report 37 shows an area 38 with a pie chart illustrating with three disks 39, 40 and 41 corresponding to the respective product A, B and C how many customers purchased the respective products and the corresponding overlap, i.e. cross purchase, how many customers purchased two or three out of the three products A, B and C. A further area 42 shows a table displaying corresponding values in plain text for sales and purchased quantity for each product A, B and C and the cross purchasing combinations AB, AC, etc. Additionally, a table in area 44 shows the segmentation of the cross purchasers into different customer segmentations, e.g. below 30 years, between 30 and 49 years, between 50 and 64 years and over 65 years old. These values are also visualized as bar diagram in area 43. The user can also define other user parameters than products for parameterization of the cross purchase report, such as branch, store, time periods or product set or user defined data sets based on e.g. product hierarchy, pre-defined product groups, import of stock keeping unit data, and user defined time intervals. Further, via provided pull-down menus further filters, etc. may be set.

Thus, the following business questions are exemplary answered by the cross purchase report:
How many people are loyal buyers of my product/brand/category?
How many repertoire customers are there? How many products do they shop across?
What are loyal/repertoire purchaser worth?
What is the profile of the loyal and repertoire shoppers?
How much could I drive brand/category sales by capturing more of their spend?
Is my category/brand meeting the needs of all my shoppers?

Further the following parameterization flexibility is provided:
Branch
Store
2 or 3 product set (mutually exclusive)
Period

The provided insights are:
Quantifies how many customers are loyal to the brand (exclusive) or mix several brands
Evaluates the impact of a new launch or a promotion on exclusive customers or mixers
Identifies which customers are to target in order to develop/reduce mixity

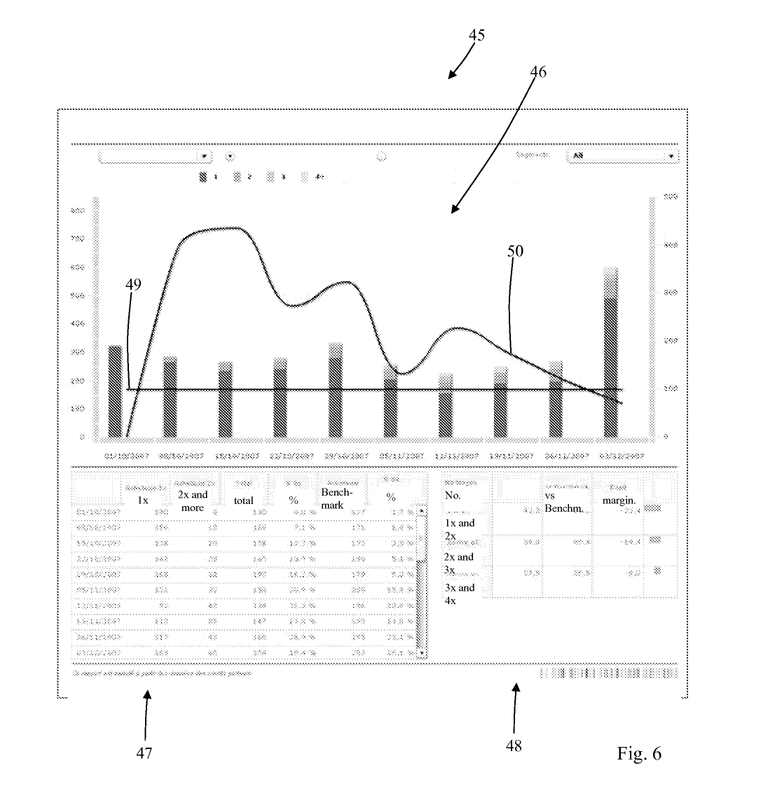

The repeat purchase report 45 shown in FIG. 6 visualizes, e.g. on a week by week basis, the behavior of customers buying a brand or a product in terms of number of “recruited customer” and number of “loyal customers”. An area 46 of the repeat purchase report visualizes how many customers bought a specific product 1 times, 2 times, 3 times or more than four times with one (coloured) bar for each time period (week). Furthermore, a flat curve 49 visualizes a base 100 benchmark and a curve 50 represents the course of an index versus the benchmark. A table in area 47 displays values of how many customers purchased a product 1 times, or 2 times and more, etc. for each time period. A further table in area 48 shows a further benchmark for the group of customers purchasing a specific product 1 and 2 times, etc. The user can also define other user parameters than products for parameterization of the repeat purchase report, such as branch, store, time periods or product set or user defined data sets based on e.g. product hierarchy, pre-defined product groups, import of stock keeping unit data, and user defined time intervals. Further, via provided pull-down menus further filters, etc. may be set.

Thus, the following business questions are exemplary answered by the repeat purchase report:
Are people repeat purchasing the new product launch?
Are people responding to a new product as well as to other products?
Has a new product launch been successful?
How has a recent promotion changed the behaviour of shoppers?

The repeat purchase provides the following parameterisation flexibility:
Branch
Store
product set
Period

It provides the following insights:
Evaluates the effects of the promotions and seasons on the repeat purchase of the products
Shows the cumulated evolution of the number of customers who repeat purchase up to 52 weeks
Compares the performance of the product sets with a benchmark

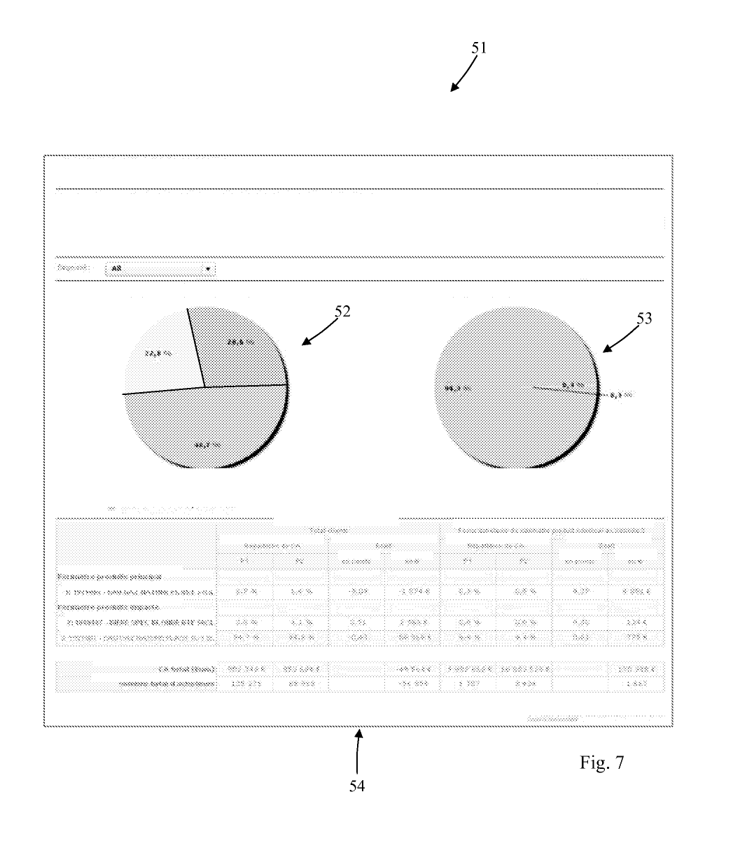

The switching report 51 illustrated in FIG. 7 shows customer shopping behavior for e.g. two time periods and allows thereby to understanding how customer shopping behavior changes in the case that new products are introduced, items are put on promotions or products are removed from the range. Further it compares how the distribution of the spend of the shoppers of a main product set in a second time period evolved between two periods. For visualization, switching report 51 shows tow pie diagrams 52, 53 for different products, three in this case. The left pie diagram 52 shows the amount of bought products in a first time period and the right pie diagram 53 for a second time period. A table in area 54 displays the respective values also in plain text. The user can also define other user parameters than products for parameterization of the switching report, such as branch, store, time periods or product set or user defined data sets based on e.g. product hierarchy, pre-defined product groups, import of stock keeping unit data, and user defined time intervals. Further, via provided pull-down menus further filters, etc. may be set.

The following business questions are answered by this report:
How many people did I attract from other categories/brands when the promotion ran?
Has my own brand been cannibalised? By how much did my sales increase?
What happened after delisting a product?
Where did the customers go?

Parameterisation flexibility:
Branch
Store
Main product set, up to 6 impact product sets, reference set (mutually exclusive)
Period

Provided insights are:
Allows to estimate the cannibalisation among a given category on the occasion of a product launch or a promotion
Identifies the share of the shoppers/turnover that have been recruited with the product launch

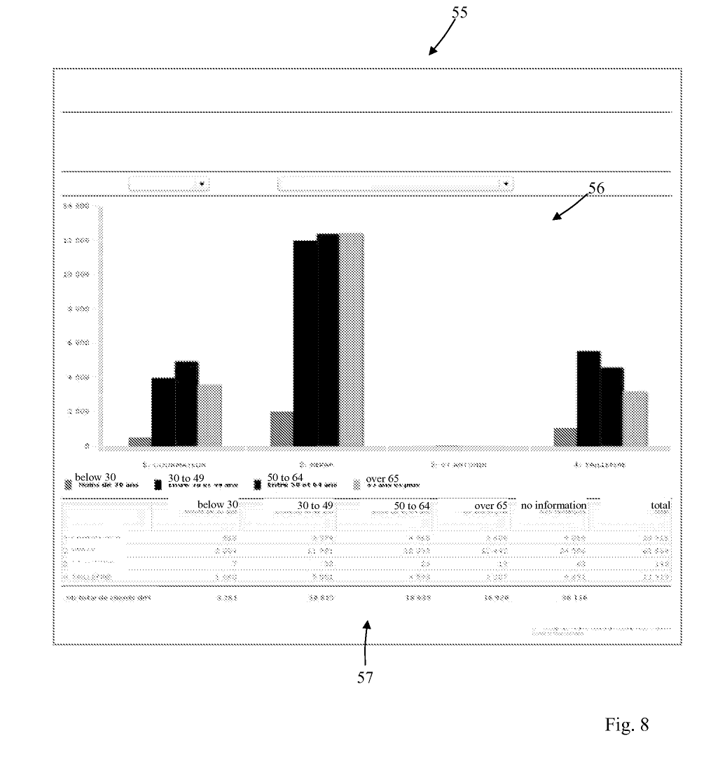

The customer profile report 55 illustrated in FIG. 8, compares and contrasts the attributes of customers who have purchased a first group of products against the attributes of customers who have purchased a second group of products. In the present case the customer profile report 55 visualizes the comparison of four different products 1 to 4 as a bar diagram area 56 of the report. In area 56 each one of the four groups of bars represents one product 1, 2, 3 or 4. The four different bars in each group of bar represent four different customer segments, namely below 30 years, between 30 and 49 years, between 50 and 64 years and over 56 years old. The values on which the bar diagram is based are also shown in plain text in a table in area 57. The user can also define other user parameters than products for parameterization of the switching report, such as branch, store, time periods or product set or user defined data sets based on e.g. product hierarchy, pre-defined product groups, import of stock keeping unit data, and user defined time intervals. Further, via provided pull-down menus further filters, etc. may be set.

The following business questions are answered by this report:
What types of customers are buying into my category, sub-category, brand or product?
How much is each customer group contributing to my category sales?
Are there any customers who are NOT buying into the category/brand?
Is the category/brand profile different to the rest of the store?

Parameterisation flexibility:
Branch
Store
Up to 5 product sets and one reference set
Period

Provided insights are:
Identifies and compares the characteristics of the customers regarding selected product sets
Shows the distribution of the key measures and customers by segment and compares it to the clientele of the retailer
Allows to define the segments with the highest potential
Identifies the strengths and weaknesses of the brand or a product by graphics

1. A method for visualizing customer insights, comprising the steps of:
receiving information data including at least one of transaction, product, shop and customer-related information data;
generating a predefined analysis report by associating respective information included in the received information data with each other;
parameterizing the generated analysis report with at least one user defined parameter; and
outputting the parameterized predefined analysis report.

2. The method of claim 1, wherein the predefined analysis report includes at least one of key measure report, assortment analysis report, cross purchase report, repeat purchase report, switching report, and customer profile report.

3. The method of claim 1, wherein the user defined parameter is based on at least one of time interval, branch, store, brand, product, group of products and user defined data sets.

4. The method of claim 1, wherein the information data includes information data relating to at least one of unique identifier, customer birthday, employee status, customer gender, nation description, town, postal code, identifier of customer, identifier of the household, customer start date, product, item quantity, price of position, identifier of shop, identifier of transaction, and date of transaction.

5. The method of claim 2, wherein the step of generating the predefined analysis report is based on associating respective information on at least one of store level, category level, brand level, product level and user defined data set.

6. The method of claim 3, wherein the user defined data set can be defined based on a product hierarchy, pre-defined product groups, import of stock keeping unit data, user defined time intervals.

7. The method of claim 1, wherein the information data is based on at least one of point-of-sale data, retailer data, transaction data, household data, shopping card data, consumer data being based on at least one of demographic data, shopping preference data and financial data.

8. The method of claim 2, wherein the key measure report is based on associating information related to a specific product or product group and a specific time period, thereby visualizing the performance of the specified product.

9. The method of claim 8, wherein the performance of the specific product is visualized for at least one of customer segment, time period, product category.

10. The method of claim 2, wherein the assortment analysis report is based on associating information related to attributes of customers who have purchased a first group of products with attributes of customers who have purchased a second group of products.

11. The method of claim 10, wherein the assortment analysis report is visualized for weekly sales and repeat purchase rate.

12. The method of claim 2, wherein the cross purchase report is based on associating information related to a vendor of a product and a specified product.

13. The method of claim 12, wherein the cross purchase report is visualized for at least one of loyal customers and repertoire customers.

14. The method of claim 2, wherein the repeat purchase report is based on associating information related to a specific product with attributes of customers.

15. The method of claim 14, wherein the repeat purchase report is visualized for at least one of time period, customer segments, competition, comparable product launch.

16. The method of claim 2, wherein the switching report is based on associating information related to customers with at least two specific products.

17. The method of claim 16, wherein the switching report is visualized for at least two time periods.

18. The method of claim 2, wherein the customer profile report is based on building customer profiles by grouping customers with similar attributes and associating the resulting customer profilers with at least one specific product.

19. A computerized system for visualizing customer insights, comprising:
at least one database having information data including at least one of transaction, product, shop and customer-related information data;
a first computer-based system having access to the database and being configured to perform the steps of:
receiving a request for generating a predefined analysis report;
receiving a user defined parameter;
generating the requested predefined analysis report by associating respective information included in the information data with each other and parameterizing the generated predefined analysis report with at least one user defined parameter;
outputting the parameterized requested predefined analysis report.

20. The computerized system of claim 19, further comprising a second computer-based system coupled to the first computer-based system via a network configured to send the request for generating the predefined analysis report and the user defined parameter and to receive and display the outputted analysis report.

21. The computerized system of claim 19, wherein the first computer-based system is further configured to generate the predefined analysis report as at least one of key measure report, assortment analysis report, cross purchase report, repeat purchase report, switching report, and customer profile report.

22. The computerized system of claim 19, wherein the user defined parameter is based on at least one of time interval, branch, store, brand, product, group of products and user defined data sets.

23. The computerized system of claim 19, wherein the information data includes information data relating to at least one of unique identifier, customer birthday, employee status, customer gender, nation description, town, postal code, identifier of customer, identifier of the household, customer start date, product, item quantity, price of position, identifier of shop, identifier of transaction, and date of transaction.

24. The computerized system of claim 19, wherein the step of generating the predefined analysis report is based on associating respective information on at least one of store level, category level, brand level, product level and user defined data set.

25. The computerized system of claim 19, wherein the user defined data set can be defined based on a product hierarchy, pre-defined product groups, import of stock keeping unit data, user defined time intervals.

26. The computerized system of claim 19, wherein the information data is based on at least one of point-of-sale data, retailer data, transaction data, household data, shopping card data, consumer data being based on at least one of demographic data, shopping preference data and financial data.

27. The computerized system of claim 26, further comprising a third computer-based system having access to the database and providing the information data.

28. A computer-readable medium including instructions which cause a computer-based system to perform the steps of:
receiving information data including at least one of transaction, product, shop and customer-related information data;
generating a predefined analysis report by associating respective information included in the received information data with each other;
parameterizing the generated analysis report with at least one user defined parameter; and
outputting the parameterized predefined analysis report.
